(19) United States
(12) Patent Application Publication
(10) Pub. No.: US 2007/0090943 A1
(43) Pub. Date: Apr. 26, 2007

(54) Passenger Transportation System, Particularly Elevator System or Escalator

(75) Inventor: Stephan Tomek, Cham (CH)

Correspondence Address: BUTZEL LONG, STONERIDGE WEST, 41000 WOODWARD AVENUE, BLOOMFIELD HILLS, MI, 48304, US

(73) Assignee: INVENTIO AG, Hergiswil NW (CH)

(21) Appl. No.: 11/553,053

(22) Filed: Oct. 26, 2006

(30) Foreign Application Priority Data
Oct. 26, 2005 (EP) 05110034.5

(51) Int. Cl. G08B 19/00; H04M 1/24; G08B 21/00

(52) U.S. Cl. 340/521; 340/679; 379/1.01

(57) ABSTRACT

A passenger transportation system, in particular an elevator system or an escalator, includes an emergency-call system that has a plurality of telephones, a monitoring system that has a plurality of monitoring units for monitoring the functioning of the passenger transportation system, and a central control unit. The monitoring units are suitable for exchanging data between themselves and with the central control unit, the monitoring units, the central control unit, and the telephones being connected to each other via one and the same data conductor.

### BACKGROUND OF THE INVENTION

The present invention relates to a passenger transportation system, in particular an elevator system or an escalator. The passenger transportation system contains an emergency-call system with a plurality of telephones and a monitoring system. The control system contains a plurality of monitoring units for monitoring the function of the passenger transportation system, and a central control unit.

Elevator systems are frequently equipped with an emergency-call system so as to provide to a person who is inside an elevator car a device with which the person can communicate with an emergency-call center should an emergency occur. For the provision of the emergency-call telephone, it is necessary to lay a telephone line in the area of the elevator hoistway. Because of this, there is a greater outlay for cabling, particularly in large building complexes with several elevator systems. In addition, in modern elevator systems, a control system with a plurality of monitoring units for monitoring the functioning of the elevator system is provided. In such systems, the monitoring units can be arranged distributed over the elevator hoistway. For the purpose of transmitting the data gathered by the individual monitoring units to a central control unit, each monitoring unit is connected by means of a network cable to the central control unit which collects, and may also analyze, the data.

In such a passenger transportation system it has proved disadvantageous that a substantial installation outlay is required to equip such a passenger transportation system with a functioning emergency-call and control system. Particularly for cabling each individual monitoring unit to the central control unit, special network cables are often used, as a result of which high costs are caused.

### SUMMARY OF THE INVENTION

An objective of the present invention is to create a passenger transportation system in which a reduced installation outlay is required to assure functionally appropriate operation of the emergency-call system and of the control system.

To fulfill this objective, a passenger transportation system, particularly an elevator system or an escalator, is proposed which contains an emergency-call system with a plurality of telephones and which contains a control system with a plurality of monitoring units and a central control unit. The monitoring units serve to monitor the functioning of the passenger transportation system. The monitoring units are suitable for exchanging data between themselves and with the central control unit. In addition, the monitoring units, the central control unit, and the telephones are connected together by one and the same data conductor.

Within the meaning of the present invention, a passenger transportation system is to be understood as an elevator system, an escalator, or a moving walk. Other systems that are suitable for transporting loads also fall within the meaning of the term “passenger transportation system”.

The basic idea of the passenger transportation system according to the present invention is to use one and the same data conductor for data communication between the monitoring units themselves, between the monitoring units and the central control unit, as well as between the telephones themselves and between them and an emergency-call center. This means that only one single data conductor must be installed, or an already installed data conductor, for example an already existing telephone network, is used. By this means, no separate network, usually an Ethernet network, is required for the monitoring system. The outlay for material and installation is substantially reduced. This results in a saving of costs.

In a preferred embodiment, the data conductor takes the form of a telephone line that is provided for an emergency-call telephone system of an elevator system or for a telephone system of a building. In other words, for example when retrofitting a building with an elevator system, an escalator, or a moving walk, a telephone line that is already installed for the telephone system of the building in question can be used as data conductor.

It is preferable for the monitoring units and/or the telephones to be connected to the data conductor by means of a subscriber line. It is preferable for a conventional telephone line to be used as subscriber line. Alternatively, other network cables can also be used.

For it to be possible for the data gathered by the monitoring unit to be transmitted by means of the data conductor, it is expedient for the monitoring units to be connected to the subscriber line via an interface, particularly a network adapter.

With regard to monitoring of the passenger transportation system, it is preferably foreseen that the monitoring units monitor the rotational speed of a motor drive, or the speed, or the direction of travel, of the passenger transportation system. As monitoring units, particular use is made of sensors, the sensors being also able to monitor the temperature and any breaks that may occur in the cable.

According to a further preferred embodiment, the monitoring units are suitable for monitoring each other. In this manner, safety-relevant functions can be monitored by several monitoring units so that, for example, redundant monitoring of the speed of the drive motor can take place. For this purpose, the monitoring units can be arranged in such manner that they exchange between themselves the data that is gathered for the function that is to be monitored. It can also be arranged that on failure of one monitoring unit another monitoring unit can be used to monitor the function.

In a further preferred embodiment, the monitoring units always contain at least one processor, a data transmission unit, and at least one interface. For example, a monitoring unit can be fitted with a printed circuit board that has several microprocessors, two microprocessors, for example, being provided for redundant monitoring of the speed of the motor drive of an elevator system.

The interface is preferably a USB interface, a PCI interface, an Ethernet interface, an XDSL interface, or a serial interface such as, for example, an RS232 interface. This allows versatile use of the monitoring units and connection of a plurality of data conductors and electronic devices. For example, in particular, an interface can be provided to make it possible to connect a laptop computer for maintenance purposes. This allows rapid identification of any sources of error.

According to a further preferred embodiment, an interface has connected to it at least one peripheral device, preferably a printer or an elevator controller. This makes it possible, for example, for a laptop computer, that has been connected for the purpose of identifying the source of a fault, to print out a fault report.

According to a further preferred embodiment, the data conductor is an Internet line that is suitable for Internet telephony. If the elevator system according to the present invention has data lines that can transmit data and speech over the Internet telephony, the installation outlay for the emergency-call system is reduced even further. One single Internet cable is sufficient to transmit and communicate all data and speech in the elevator system. The volume of data and speech that can be transmitted is substantially increased, as is also the speed of its transmission. At the same time, the connection costs are substantially reduced.

### DESCRIPTION OF THE DRAWINGS

The above, as well as other, advantages of the present invention will become readily apparent to those skilled in the art from the following detailed description of a preferred embodiment when considered in the light of the accompanying drawings in which:

FIG. 1 is a schematic block diagram representing the functional principle of an embodiment of the passenger transportation system according to the present invention with an emergency-call system and a monitoring system; and

FIG. 2 is an enlarged schematic representation of one of the monitoring units shown in FIG. 1.

### DESCRIPTION OF THE PREFERRED EMBODIMENT

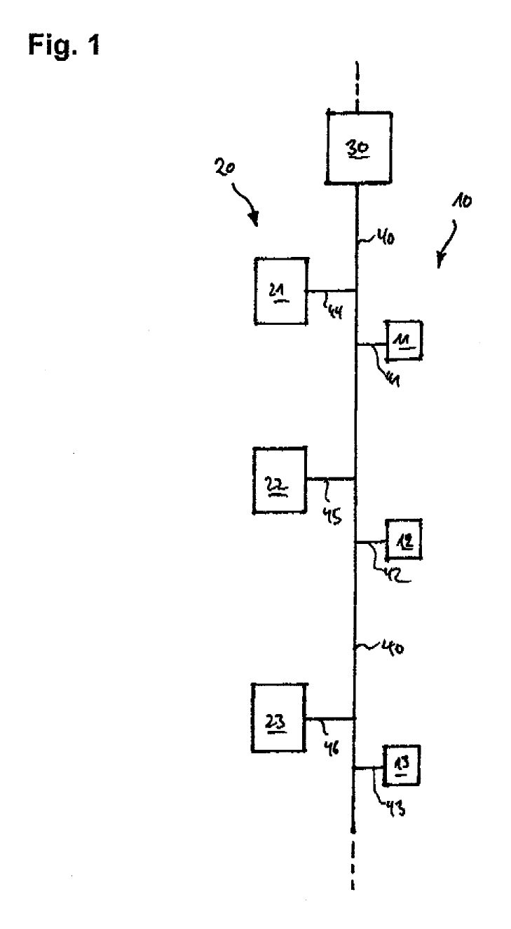

FIG. 1 shows diagrammatically the functional principle of an embodiment of the passenger transportation system according to the present invention in the form of an elevator system. The elevator system has several elevator hoistways in each of which at least one elevator car (not shown) can be caused to move in a vertical direction.

The elevator system contains an emergency-call system 10 with several telephones 11, 12, 13, with each of these telephones 11, 12, 13 being assigned to an elevator car of the elevator system.

Also provided is a monitoring system 20 with several monitoring units 21, 22, 23, each of the monitoring units 21, 22, 23 being assigned to an elevator hoistway and being provided with, for example, a speed sensor for monitoring the speed of travel of the respective elevator car. The monitoring units 21, 22, 23 are connected to an elevator controller (not shown) that accepts possible errors and warnings. The monitoring units 21, 22, 23 are arranged in such manner that they can exchange data between themselves as well as with a central control unit 30 (alarm center and call center). By this means, should faulty functioning of the elevator system be detected by one of the monitoring units 21, 22, 23, a signal for notification of the faulty functioning can be transmitted to the control center 30. Furthermore, the monitoring units 21, 22, 23 can receive data, for example in the form of control signals from the control center 30. This makes remote control of the monitoring units 21, 22, 23 possible. Equally, the telephones 11, 12, 13 can exchange data with the control unit 30 and/or with an emergency-call center (not shown).

As FIG. 1 also shows, for the exchange of data described above, the monitoring units 21, 22, 23, the central control unit 30, and the telephones 11, 12, 13, are simultaneously connected to each other over one and the same data conductor 40. The data conductor 40 takes the form of the same telephone line as is also used for the telephone system of the building in which the elevator system is located. Connection of the individual monitoring units 21, 22, 23, and of the telephones 11, 12, 13, to the data conductor takes place in each case via a subscriber line 41, 42, 43, 44, 45, 46, each of the subscriber lines 41, 42, 43, 44, 45, 46 also taking the form of a telephone line.

With the system described above, coupling of the monitoring system 20 with the emergency-call system 10 is achieved through the components of the two systems 10, 20 being connected to the one single data conductor 40 in the form of a telephone line, the data conductor 40 and the monitoring units 21, 22, 23 being particularly suitable for enabling an exchange of data between the individual monitoring units 21, 22, 23 themselves as well as with the central control unit 30. By this means, the relatively high cabling outlay relative to the state of the art, that is inevitably associated with high procurement costs and a high installation and maintenance outlay, is substantially reduced. It is also possible for a telephone line that is already present in a building to be used as data conductor 40.

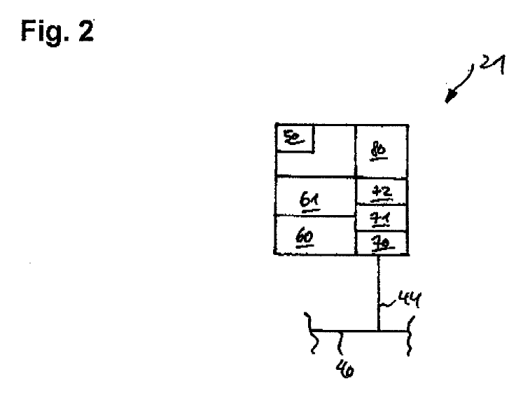

FIG. 2 shows diagrammatically the individual components of the monitoring unit 21 shown in FIG. 1. As an interface 70, the monitoring unit 21 has a network adapter or modem that is embodied as a USB interface, Ethernet interface, XDSL interface, or PCI interface, and which enables connection of the monitoring unit 21 to the data conductor 40 over the subscriber line 44. An interface 71 (USB interface) is provided for connection of a laptop computer to the monitoring unit for maintenance purposes, for example. A further interface 72 serves to connect a printer or an elevator controller that accepts possible errors and warnings. Alternatively, additional interfaces can be provided to enable the connection of further peripheral devices. Furthermore, the control unit 21 has a sensor 80 for monitoring the speed of the elevator car. The data that is gathered by the sensor 80 is transmitted to a first processor 60 that stores the gathered data and readies it for data transmission over the data conductor 40. A further processor 61 is constructed identical to the processor 60 and can have the same function. The two processors 60, 61 are arranged in such manner that they can monitor each other. The processors 60, 61 not only monitor themselves for locally occurring faults but also verify whether the signals that are transmitted to the respective other processors 60 or 61 are in a predefined tolerance range that is programmed on the processors 60, 61. As a further component, the monitoring unit 21 has a data transmission unit 50 in the form of a modem. The modem can, for example, be connected to a telephone exchange.

The monitoring units 22 and 23 that are still present in addition to the monitoring unit 21 are constructed identical to the monitoring unit 21 that is described in greater detail in FIG. 2. However, in further preferred embodiments, a different construction can be provided. In particular, the sensor 80 can also be arranged to monitor other functions than the speed of the elevator system such as, for example, to monitor the rotational speed of a motor drive or the direction of travel of the elevator car.

It is also possible for a different number of processors and/or interfaces and/or data transmission units to be provided. In the embodiments described above, it is also preferable for processors of different monitoring units to be able to monitor each other.

The data conductor 40 can also be an Internet line that is suitable for Internet telephony. IP telephony (also Internet telephony, DSL telephony, or Voice over IP, VoIP for short) is telephoning over a computer network using the Internet protocol, often referred to colloquially as telephoning via the Internet. For connection to conventional telephone networks, switching computers—so-called gateways—are used. For speech transmission, the infrastructure of an existing network is economically shared with other communications services. VoIP is an abbreviation of “voice over Internet protocol”. For the subscriber, telephoning with IP telephony is exactly the same as in classical telephony. As in conventional telephony, a telephone conversation is divided into two basic operations. The operations are establishment of the connection and transmission of the conversation. However, in contrast to classical telephony, with VoIP no “lines” are connected but speech is transported in small packets, possibly over different routes.

If the elevator installation according to the present invention has data lines that can transmit data and speech over the Internet telephony, the installation outlay of the emergency-call system is reduced even further. The volume of data and conversations that can be transmitted is substantially increased, as is also the speed of its transmission. At the same time, the connection costs are substantially reduced.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A passenger transportation system, in particular an elevator system or escalator, with an emergency-call system that includes a plurality of telephones, and with a monitoring system that includes a plurality of monitoring units for monitoring the functioning of the passenger transportation system and a central control unit, comprising:
the monitoring units being suitable for exchanging data between themselves and with the central control unit; and
a single data conductor being connecting the monitoring units, the central control unit and the telephones to each other.

2. The passenger transportation system according to claim 1 wherein said the data conductor is a telephone line that is provided for an emergency-call telephone system of an elevator system or for a telephone system of a building.

3. The passenger transportation system according to claim 1 wherein at least one of the monitoring units and the telephones are each connected to the data conductor by a subscriber line.

4. The passenger transportation system according to claim 3 wherein the monitoring units are connected to said subscriber line via an interface such as a network adapter or a modem.

5. The passenger transportation system according to claim 1 wherein the monitoring units monitor at least one of rotational speed of a motor drive, a speed, and a direction of travel of the passenger transportation system.

6. The passenger transportation system according to claim 1 wherein the monitoring units are suitable for mutual monitoring.

7. The passenger transportation system according to claim 1 wherein the control unit contains at least one processor, one data transmission unit, and at least one interface.

8. The passenger transportation system according to claim 7 where in said at least one interface is one of a USB interface, a PCI interface, an Ethernet interface, an XDSL interface and a serial interface.

9. The passenger transportation system according to claim 7 wherein said at least one interface is connected to at least one peripheral device such as a printer or an elevator controller.

10. The passenger transportation system according to claim 1 wherein said data conductor is an Internet line that is suitable for Internet telephony.

11. An elevator installation with an emergency-call system comprising:
a plurality of telephones;
a monitoring system including a plurality of monitoring units for monitoring the functioning of the elevator installation;
a central control unit; and
a single data conductor being connecting said monitoring units, said central control unit and said telephones to each other, said monitoring units being suitable for exchanging data between themselves and said central control unit.
